(19) United States
(12) Patent Application Publication
(10) Pub. No.: US 2026/0245051 A1
(43) Pub. Date: Aug. 20, 2026

(54) DYNAMIC CALL-TO-ACTION ADAPTATION SYSTEM

(71) Applicant: CAPITAL ONE SERVICES, LLC, McLean, VA (US)

(72) Inventors: Bryan TAMAYO, Allen, TX (US); William MERKEL, Garland, TX (US)

(21) Appl. No.: 19/054,153

(22) Filed: Feb. 14, 2025

(51) Int. Cl. G06Q 50/00

(52) U.S. Cl. CPC G06Q 10/40

(57) ABSTRACT

In some implementations, a system may monitor one or more user interactions with a web page presented on a user device, wherein the web page is associated with a call-to-action (CTA) element having a set of engagement properties. The system may generate behavior information based on the one or more user interactions. The system may obtain decision information defining one or more conditions for updating one or more engagement properties of the set of engagement properties, wherein each condition of the one or more conditions is associated with a user intent level. The system may update one or more engagement properties of the set of engagement properties based on the behavior information satisfying one or more conditions indicated by the decision information. The system may provide an updated CTA element to the user device, wherein the updated CTA element is associated with the one or more updated engagement properties.

### BACKGROUND

A graphical user interface is a form of user interface that allows users to interact with electronic devices. A web browser may provide a graphical user interface that presents web pages. A user may navigate to a web page by entering a web address into an address bar of the web browser and/or by clicking a link that may be displayed in an application or another web page. Navigation to a web page may consume resources of a user device on which the web browser is installed, may consume resources of a web server that serves the web page to the user device, and may consume network resources used for communications between the user device and the web server. Furthermore, in cases where a web page includes interactive content (e.g., tools, surveys, or other content that takes user input and/or responds to user actions), actions that are performed with respect to the interactive content may consume additional resources of the user device, the web server, and/or the network.

### SUMMARY

Some implementations described herein relate to a system for dynamic call-to-action (CTA) adaptation. The system may include one or more memories and one or more processors communicatively coupled to the one or more memories. The one or more processors may be configured to monitor one or more user interactions with a web page presented on a user device, wherein the web page is associated with a CTA element having a set of engagement properties. The one or more processors may be configured to generate behavior information based on the one or more user interactions with the web page. The one or more processors may be configured to obtain decision information defining one or more conditions for updating one or more engagement properties of the set of engagement properties, wherein each condition of the one or more conditions is associated with a user intent level. The one or more processors may be configured to update one or more engagement properties of the set of engagement properties based on the behavior information satisfying one or more conditions indicated by the decision information, wherein each updated engagement property is updated from a first respective action state to a second respective action state, and wherein the updated CTA element is associated with the one or more updated engagement properties.

Some implementations described herein relate to a method for dynamic CTA adaptation. The method may include monitoring, by a system, one or more user interactions with a web page presented on a user device, wherein the web page is associated with a CTA element having a set of engagement properties. The method may include generating, by the system, behavior information based on the one or more user interactions with the web page. The method may include obtaining, by the system, decision information defining one or more conditions for updating one or more engagement properties of the set of engagement properties, wherein each condition of the one or more conditions is associated with a user intent level. The method may include updating, by the system, one or more engagement properties of the set of engagement properties based on the behavior information satisfying one or more conditions indicated by the decision information. The method may include providing, by the system, an updated CTA element to the user device, wherein the updated CTA element is associated with the one or more updated engagement properties.

Some implementations described herein relate to a non-transitory computer-readable medium that stores a set of instructions. The set of instructions, when executed by one or more processors of a system, may cause the system to monitor one or more user interactions with a web page presented on a user device, wherein the web page is associated with a CTA element having a set of engagement properties. The set of instructions, when executed by one or more processors of the system, may cause the system to generate behavior information based on the one or more user interactions with the web page. The set of instructions, when executed by one or more processors of the system, may cause the system to obtain decision information defining one or more conditions for updating one or more engagement properties of the set of engagement properties. The set of instructions, when executed by one or more processors of the system, may cause the system to update one or more engagement properties of the set of engagement properties based on the behavior information satisfying one or more conditions indicated by the decision information. The set of instructions, when executed by one or more processors of the system, may cause the system to provide an updated CTA element to the user device, wherein the updated CTA element is associated with the one or more updated engagement properties.

### BRIEF DESCRIPTION OF THE DRAWINGS

FIG. 1 is a diagram of an example associated with a dynamic call-to-action (CTA) adaptation system, in accordance with some embodiments of the present disclosure.

FIGS. 2A-2B are diagrams of examples associated with a dynamic CTA adaptation system, in accordance with some embodiments of the present disclosure.

FIG. 3 is a diagram of an example of training and using a machine learning model in connection with a dynamic CTA adaptation system, in accordance with some embodiments of the present disclosure.

FIG. 4 is a diagram of an example environment in which systems and/or methods described herein may be implemented, in accordance with some embodiments of the present disclosure.

FIG. 5 is a diagram of example components of a device associated with a dynamic CTA adaptation system, in accordance with some embodiments of the present disclosure.

FIG. 6 is a flowchart of an example process associated with a dynamic CTA adaptation system, in accordance with some embodiments of the present disclosure.

### DETAILED DESCRIPTION

The following detailed description of example implementations refers to the accompanying drawings. The same reference numbers in different drawings may identify the same or similar elements.

In web design, user engagement may relate to a degree to which visitors interact with and/or pay attention to a website. For example, user engagement may encompass actions such as interacting with content elements, filling out forms, applying for services, purchasing products, commenting, sharing, liking, or any other form of interaction with or attention to web content. User engagement is an important consideration in web design for several reasons, including improved user experience, increased conversion rates, higher retention rates, better search engine optimization performance, and/or improved website analytics. For example, when users find a website interesting, informative, or entertaining, users are more likely to spend time on the website, leading to increased satisfaction and loyalty. In addition, engaged users are more likely to convert or to engage with a call to action, which is an interactive element or a prompt that encourages users to perform a specified action (e.g., making a purchase, applying for services, signing up for a newsletter, signing up for a free trial, sharing on social media, contacting support personnel, or the like). Furthermore, users that are engaged with a website and the associated content are more likely to return to the website and spend time on the website, which reduces bounce rates, increases overall retention, improves user engagement metrics that search engines consider when ranking websites, and/or provides valuable analytics related to user behavior and preferences (e.g., conversion rates, click-through rates, social shares, and/or comments, among other examples) that can help website developers to understand the content that increases user engagement and to make informed decisions about future improvements.

However, despite user engagement being an important factor for increasing conversion rates, creating a positive user experience, building brand loyalty, and/or achieving long-term success, existing website designs often struggle to drive conversions and/or to retain user attention. When a web page serves content that is not relevant to a user and/or is not relevant to the user's current intent with respect to the website, the user may cease to actively engage with the web page and/or may navigate away from the page. For example, where a new visitor to an ecommerce website is served multiple, forceful content elements urging the visitor to make a purchase, the user may become disinterested or fatigued of the content elements and leave the site. Similarly, where a visitor to an ecommerce website is ready to make a purchase, the user may become disinterested with the website if website's navigation and content elements make it difficult to initiate the purchase.

Additionally, when users are unable to locate desired content and/or interactive elements, the users may cease to actively engage with a web page and/or may leave the web page. For example, a website may fail to retain user attention and/or to drive conversions due to factors such as static and/or generic content and call-to-action (CTA) elements, complex or confusing navigation structures that interfere with users finding the content that they are interested in at the time at which they are interested, a lack of personalized content or recommendations tailored to user interest, intent, and preferences, and/or slow load times that frustrate users and lead to higher bounce rates, among other examples.

Accordingly, in some cases, web content may be designed to increase conversion rates and/or improve user engagement for users that have not interacted with a web page element, user that are likely to exit or close a website, or idle or inactive users, among other examples. However, existing efforts to increase conversion rates and/or improve user engagement suffer from various drawbacks. For example, in some cases, a website may include static CTA elements that remain constant regardless of user behavior, that fail to adapt to a user intent or user engagement level, and result in reduced conversion rates and increased bounce rates as users tend to increasingly ignore the static CTA elements over time. In another example, some websites rely heavily on generic pop-ups and/or animated content to capture user attention and drive conversions, but an overabundance of generic (e.g., non-personalized) pop-ups and/or animated content that is not tailored towards user intent may create negative user experiences that least to frustration and increased bounce rates. Furthermore, users may perceive excessive, generic pop-ups or animated content as intrusive, which may lead to negative brand perception and reduce the likelihood of a user continuing to engage with a website. Additionally, the use of generic, static content elements and/or generic, time-triggered content (e.g., content displayed after a certain time period) may distract from a user's natural navigation flow and deter the user from taking action that reflects the user's current intent. For example, such generic, static content elements and/or generic, time-triggered content may lack personalization based on user behavior and intent and may suffer from ineffectiveness due to marginal or no relevance to a current browsing session. Similarly, persistent banners or headers that feature generic CTA elements that are visible throughout a user's interaction with a web page tend to be distracting and may occupy valuable real estate on a display. As a result, inefficient user navigation may lead to a higher number of application programming interface (API) calls and/or increased usage of computing and network resources. For example, user-requested content may require separate requests to the backend (e.g., validating input, fetching new screen content and formatting, loading data for each step, or the like) where the user navigates across multiple pages in order to locate information matching the level of intent associated with the user. Similarly, generic content that is irrelevant to the user may require additional, separate requests to the backend, thereby wasting computing and network resources.

Some implementations described herein relate to techniques to provide a dynamic CTA adaptation system. For example, as described herein, some implementations may update engagement properties associated with a CTA element in accordance with user behavior information that is generated based on user interaction with a web page. For example, in some implementations, the engagement property may be updated from a first respective action state to a second respective action state. In some implementations, the system may be enabled to skip the updating of engagement properties based on the behavior information satisfying a condition associated with a final user intent level. For example, in some implementations, the CTA element may be updated to include engagement properties that may indicate that the user's interactions are associated with having a relatively high intent to interact with the CTA element. Additionally, the behavior information may be generated based on historical user interactions with the web page or with web pages associated with the web page and based on user interactions with content elements on the web page. In some implementations, a destination resource link associated with the CTA element may be updated based on the behavior information. In some additional implementations, the monitored interactions of a user on the web page may include interactions across different platforms. In some implementations, the engagement properties may be updated based on predicted behavior information according to the behavior information associated with the user.

In this way, some implementations may provide dynamic and personalized CTA elements and/or web pages in order to strategically engage users at a time when they may be ready to interact with a CTA element. Similarly, some implementations may provide content having engagement properties that nurture a customer towards engaging with the CTA element and/or taking additional action associated with the web page. Accordingly, by adapting and optimizing the engagement properties associated with the CTA elements, the techniques described herein may conserve resources that may otherwise be consumed where the user leaves the web page, is unable to efficiently navigate the webpage, or becomes inactive on the web page. Additionally, or alternatively, by updated engagement properties of the CTA element based on behavior information associated with user intent levels, some implementations described herein may increase conversion rates, improve user experience, and avoid wasting resources that may have been consumed by the user navigating and interacting with the website without completing a conversion action and/or without completing the task that the user intended to perform. Similarly, computing resources and/or network resources may be conserved by reducing an amount of navigation performed by the user. For example, inefficient user navigation across pages on a website, or resulting from a user visiting a page multiple times, may cause higher processor and memory usage on backend servers as requests from the user are processed.

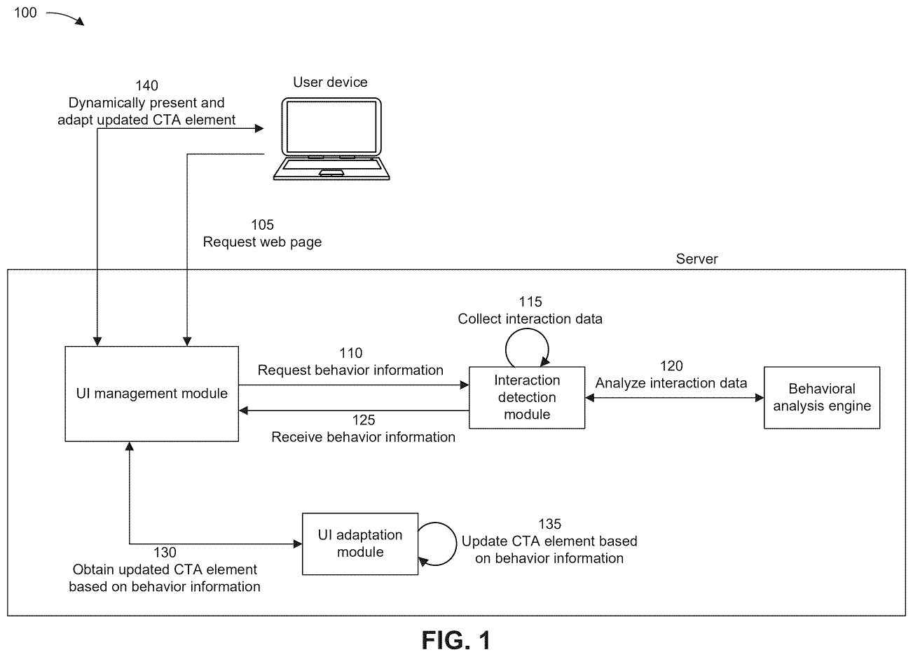

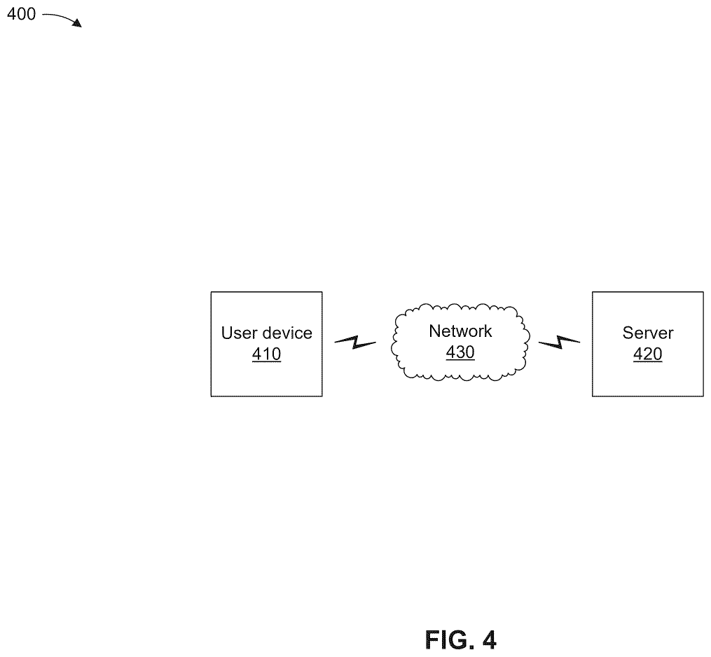

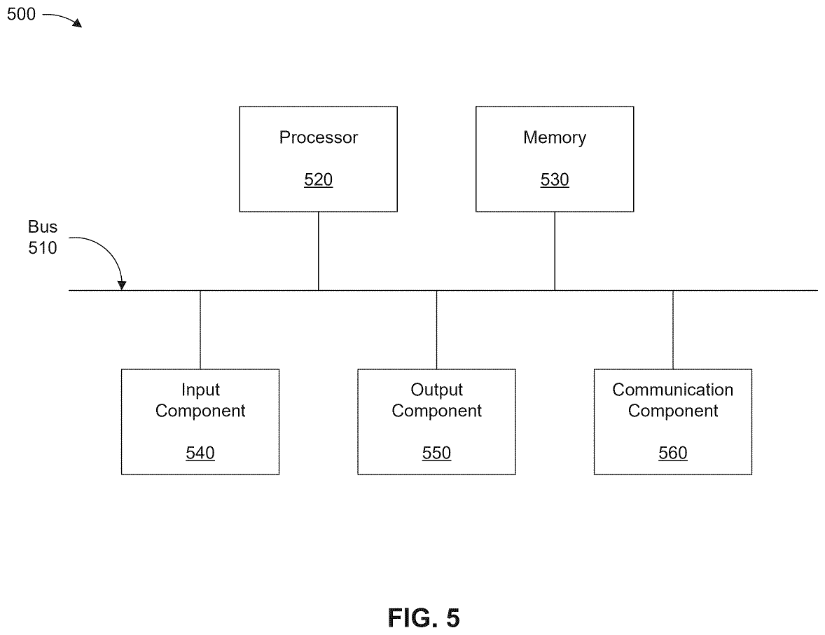

FIG. 1 is a diagram of an example 100 associated with a dynamic CTA adaptation system. As shown in FIG. 1, example 100 includes a user device and a server. These devices are described in more detail in connection with FIGS. 4 and 5. As described herein, the user device may be associated with a user and may implement a user interface (UI) (e.g., a graphical UI), such as a web browser, a mobile application, an interactive chat and/or chatbot system, or another suitable channel. For example, the user device may include a web browser application, which the user device may execute to load web pages.

As shown in FIG. 1, and by reference number 105, the user device may communicate with the server to request web content, such as a web page. For example, the user device may transmit, and a UI management module may receive, the request for the web page. In some implementations, the web page may include and/or may be associated with a CTA element, where the CTA element may have a set of engagement properties. For example, the set of engagement properties may include one or more display or content properties, including visual appearance (e.g., color, shape, or the like), content (e.g., text, graphics, images, or the like), rendering (e.g., two-dimensional and/or three-dimensional visual effects, or the like), visual transition animations, messaging, and/or destination universal resource locators (URLs), among other examples.

As further shown in FIG. 1, and by reference number 110, the UI management module may request, and an interaction detection module may receive, a request for behavior information (e.g., engagement data). For example, the behavior information may include data associated with interactions between the user and the web page, including components associated with the web page.

As shown by reference number 115, the interaction detection module may collect interaction data associated with the user device. In some implementations, the interaction detection module may monitor user interactions with the web page presented on a user device. For example, the interaction detection module may collect interaction data associated with the user, including mouse movements, clicks, interactions (e.g., with content elements, with CTA elements, or the like), time-based interactions (e.g., measuring time periods between interactions, or the like), time-based indicators (e.g., time spent hovering a mouse over content, time spent viewing certain content, session duration, or the like), video and/or audio plays, event tracking, rage clicks (e.g., repeated clicks on non-responsive content elements), scroll speed, navigation path (e.g., navigation to a linked page, navigation path associated with the user journey to the web page, navigation of a mouse on the web page, or the like), text input, highlighting and/or copying and pasting of web page content, utilization of web browser plugins, and/or eye tracking data (e.g., monitored via one or more cameras integrated with and/or external to a user device), among other examples.

Additionally, in some implementations, the UI management module and/or the interaction detection module may collect user context data (e.g., via a user context data repository in communication with the server and/or the user device). For example, the user content data may include data associated with a user, including a user profile, user account information, information input and/or provided to the user device, or the like. Additionally, or alternatively, the user context data may include information associated with a history of interactions between the user and the web page, between the user and related web pages, between the user and the server and/or additional servers associated with the user, or the like. For example, the user context data may include information and/or data associated with the user, including internet protocol (IP) address, cookie data, tracking pixel data, fingerprinting data (e.g., operating system, screen size, browser settings, time zone, or the like), cross-site tracking data, entity tags, supercookies, saved user preferences, or the like. Additionally, or alternatively, the techniques described herein may include utilizing an API to access information associated with the user, the user account associated with the user, and/or with the request for the web page received from the user device. For example, the techniques described herein may include accessing information associated with the user, including historical interactions between the user and the web page and/or related web pages, user activity and/or interactions across different platforms (e.g., on a desktop-based web browser, on a mobile browser, on a mobile application, or the like).

As shown by reference number 120, a behavioral analysis engine may analyze the interaction data associated with the user. In some implementations, the behavioral analysis engine may determine one or more user intent levels associated with the user, according to the interaction data associated with the user. For example, the user intent levels associated with the user may dynamically change during the user's session (e.g., the duration of time the user actively views the web page) based on the user interaction with the web page.

For example, where a user is interacting with an ecommerce web page, the behavioral analysis engine may determine (e.g., either alone or in combination with the interaction detection module) that the user is associated with a low-intent level based on the interaction data indicating that the user has a relatively low session duration and has a relatively low level of interaction with the web page. Similarly, for example, the behavioral analysis engine may determine that the user is associated with a medium-intent level based on the interaction data indicating that the user's session duration has increased, and the user's level of interaction with the web page has increased. Additionally, for example, the behavioral analysis engine may determine that the user is associated with a high-intent level (e.g., a final-intent level) based on the interaction data indicating that the user's session duration has increased and the user's level of interaction with the web page has increased. Accordingly, in some implementations, the high-intent level may indicate that the user is associated with a relatively high likelihood of engaging with the CTA element, or otherwise performing an action or interaction associated with the web page.

In some implementations, the behavioral analysis engine may identify an intent level of a user and/or predict the engagement level of a user using artificial intelligence/machine learning (AI/ML) techniques described herein, thereby enabling the CTA element to be customized to an intent level and/or dynamically-changing intent levels associated with the user. For example, such customizations may be used to dynamically update engagement properties of the CTA element according to an identified and/or predicted intent level associated with the user.

As shown by reference number 125, the interaction detection module may provide, and the UI management module may receive, behavior information based on the behavior analysis engine analyzing the interaction data. As shown by reference number 130, the UI management module may obtain updated the CTA element based on the behavior information.

As shown by reference number 135, a UI adaptation module may update the CTA element based on the behavior information. In some implementations, the UI adaptation module may obtain decision information that indicates one or more conditions for updating engagement properties associated with one or more CTA elements. In some implementations, the conditions for updating the engagement properties may be associated with one or more user intent levels. Additionally, in some implementations, one or more of the engagement properties may be updated from a first respective action state to a second respective action state. For example, the decision information may indicate that a visual property associated with the CTA element may be updated based on the behavior information indicating that the user intent level has transitioned from a low-intent level to a medium-intent level. In some implementations, the behavior information may indicate user intent level across one or more spectrums of user intent level, where each spectrum may be associated with a different type of behavior information and each spectrum may be weighted the same or differently to indicate user intent level. Additionally, the engagement information may indicate user intent level transitioning from a relatively low-intent level to a relatively higher intent level and/or from a relatively high intent level to a relatively lower intent level, over one or more time periods. For example, where a user of an ecommerce web page has viewed a majority of a product information page, has interacted with product reviews, and has viewed a pop-up window relating to product shipping policies, the UI adaptation module may update the engagement properties (e.g., color properties, content properties, animation properties, or the like) associated with the CTA element from a “Learn More” state to a “Buy Now” state in order to encourage the user to engage with the CTA according to these indicators of the user intent level.

In some implementations, the UI adaptation module may update the engagement properties associated with the CTA element based on predicted behavior information associated with the user. Additionally, the engagement properties may be updated based on the predicted behavior information satisfying one or more conditions indicated by the decision information. In some implementations, where the predicted behavior information indicates that the user intent level is likely to increase from a relatively low user intent level to a relatively higher user intent level, the engagement properties of the CTA element may be updated in order to increase the probability that the user continues interacting in a manner that increases the user intent level towards a specified action (e.g., interaction with the CTA element, submission of an application, conversion, purchase, or the like). Additionally, or alternatively, predicted behavior associated with the user may be utilized to indicate that the user has reached or will soon be reaching a final user intent level.

In some implementations, the UI adaptation module may update the CTA element based on data and/or information associated with the user. For example, the UI adaptation module may update the CTA element based on the user context data (e.g., user profile, user identification, user preferences, or the like) associated with the user. Accordingly, the user context data may be used in determining the user intent level associated with the user.

In some implementations, the user intent level may be associated with a final user intent level, which may indicate that the user has reached a maximum user intent level and that there is a high probability that the user is ready to interact with the CTA element. For example, where the behavior information satisfies an indicated quantity of conditions associated with the decision information, the engagement properties of the CTA element may be updated to a final state that is intended to cause the user to interact with the CTA element.

Additionally, for example, where the user has performed a relatively small quantity of interactions with the web page, the engagement properties may transition from an action state associated with a low user intent level to an action state associated with a medium user intent level. For example, a CTA element may transition from an unanimated “Welcome” state (e.g., associated with the low user intent level) to an unanimated “Learn More” state. In contrast, where the user has performed a relatively large quantity of interactions with the web page, the engagement properties may transition from an action state associated with the medium user intent level to a final user intent level (e.g., the highest user intent level). For example, the CTA element may transition from the unanimated “Learn More” state to an animated “Buy Now” state, thereby matching the determined user intent level associated with the user.

In some implementations, the UI adaptation module may skip or cease updated engagement elements associated with the CTA element based on the user intent level reaching the final user intent level. For example, where the UI adaptation module has transitioned the CTA element to the animated “Buy Now” CTA element, the UI adaptation module may refrain from further updating the CTA element and associated engagement properties. As a result, the CTA element may remain as the animated “Buy Now” CTA element despite the behavior information indicating that the user intent level has decreased to a lower user intent level (e.g., from the final user intent level to the low user intent level).

In some implementations, the UI adaptation module may update a destination resource link associated with the CTA element based on the behavior information. Furthermore, the UI adaptation module may update the destination resource link based on the behavior information satisfying one or more conditions indicated by the decision information. For example, the UI adaptation module may insert and/or update a URL (e.g., via a URL manipulation API, among other examples) associated with the CTA based on the decision information and/or one or more additional behavioral filters, among other examples. As a result, when the user interacts with (e.g., clicks) the CTA element, the web browser may be directed to the updated URL, where the updated URL (e.g., and associated webpage) may be tailored to the current user intent level. Additionally, or alternatively, the UI adaptation module may insert and/or update the URL to be personalized to the user according to user context data, including user preferences, historical user interaction patterns, or the like. Similarly, the UI adaptation module may insert and/or update the URL to include a personalized navigation path according to the behavior information (e.g., including predicted behavior information) and/or user context data, where the web page and any included CTAs associated with the updated URL are personalized to the user.

In some implementations, one or more components of the server may be configured to implement user tracking and/or user data storage policies, including configurations to anonymize collected data, to implement user consent capture protocols, and/or minimize retention of user data, among other examples, and/or otherwise implement data collection and storage policies.

As shown by reference number 140, the UI management module may dynamically present and adapt the updated CTA element to the user device. In some implementations, the updated CTA element may be associated with one or more updated engagement properties. For example, the updated CTA element include one or more updated visual properties (e.g., color properties, animation properties or the like), updated content properties (e.g., fonts, typefaces, or the like), and updated content (e.g., text, graphics, images, or the like), among other examples. For example, the updated CTA element may include different engagement properties (e.g., color properties, animation properties, and/or content properties, among other examples) than the previously-presented engagement properties associated with the CTA, where the different engagement properties may be dynamically updated according to a changing user intent level.

Additionally, the UI management module may provide the updated CTA element to the user device, and the user device may provide, and the server may receive, additional user interactions associated with the web page. Based on the additional user interactions received from the user device, the server may provide updated the CTA element, associated with updated engagement properties, to the user device. As a result, the CTA element may be dynamically updated based on changing behavior information associated with the user (e.g., behavior information determined according to updated interaction data associated with the user). For example, where the user inputs text on the web page, the server may further update the engagement properties associated with the CTA element based on the text being associated with a change in the user intent level

As described herein, some implementations may provide dynamic and personalized CTA elements and/or web pages in order to strategically engage users. For example, the CTA elements may be dynamically updated at a time when the user may be ready to interact with a CTA element. Additionally, or alternatively, the CTA elements may be dynamically updated to provide content with engagement properties that nurture a customer towards engaging with the CTA element and/or taking additional action associated with the web page. Accordingly, by adapting and optimizing the engagement properties associated with the CTA elements, the techniques described herein may conserve resources that may otherwise be consumed when the user leaves the web page, is unable to efficiently navigate the webpage, or becomes inactive on the web page. Additionally, or alternatively, by updated engagement properties of a CTA element based on behavior information associated with user intent levels, some implementations described herein may increase conversion rates, improve user experience, and avoid wasting resources that may have been consumed by the user navigating and interacting with the website without completing a conversion action and/or without completing the task that the user intended to perform. Similarly, computing resources and/or network resources may be conserved by reducing an amount of navigation performed by the user.

As indicated above, FIG. 1 is provided as an example. Other examples may differ from what is described with regard to FIG. 1.

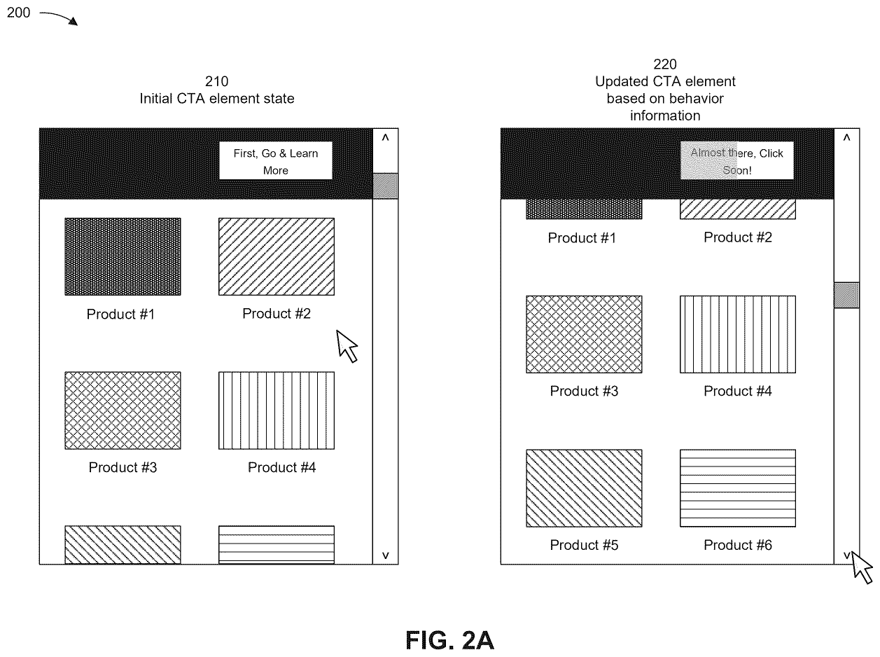

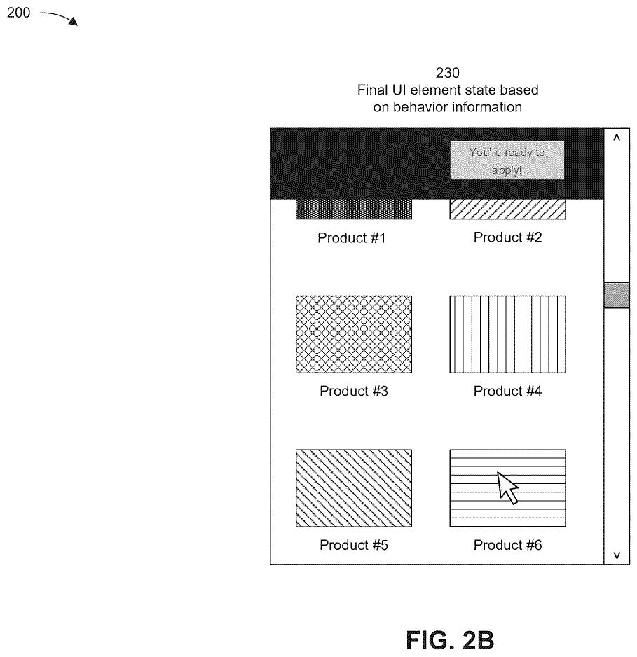

FIGS. 2A-2B are diagrams of examples 200 associated with a dynamic CTA adaptation system. Additionally, FIGS. 2A-2B are a particular example implementation of FIG. 1 in a web page use case.

As shown in FIGS. 2A-2B, a web page may include a set of UI elements associated with an ecommerce shopping web page, including a CTA element. As shown in FIG. 2A, and by reference number 210, the web page may include an initial CTA element state, where the CTA element may be static (e.g., unanimated) and include initial CTA text, which states “First, Go & Learn More.” For example, where a user first begins a session on the web page, the behavior information (e.g., session duration, scroll speed, quantity of interactions, or the like) may indicate that the user is associated with a relatively low user intent level. As a result, the CTA element may reflect that the user is currently associated with a relatively low probability of interacting with the CTA element.

As shown by reference number 220, the CTA element may be updated based on the behavior information indicating that the user is associated with an increased and/or emerging user intent level. This increased and/or emerging user intent level may indicate an increasing probability that the user will interact with the CTA. For example, where the user has increased the scroll speed, has viewed a relatively larger area of the web page, and/or has a session duration time that satisfies (e.g., meets or exceeds) a threshold, the CTA element may transition to an animated state, accompanied by updated content, which states “Almost there, Click Soon!” As a result, the updated CTA element may include engagement properties that encourage the user to continue browsing the web page and/or engaging with one or more product pages.

As shown in FIG. 2B, and by reference number 230, the CTA element may be updated to a final element state based on the behavior information indicating that the user is associated with a final user intent level. This final user intent level may indicate that the user intent level has satisfied a condition indicating that the user is likely ready to engage with the CTA. For example, where the user has viewed a relatively larger area of the web page, has increased the scroll speed, has a session duration time that satisfies (e.g., meets or exceeds) a threshold, and/or has hovered over a product (e.g., Product #6), the CTA element may transition to a fully-animated state, accompanied by updated content, which states “You're ready to apply!” As a result, the updated CTA element may include engagement properties that encourage the user to interact with the CTA element. For example, the CTA element may direct the user to submit an application for financing, purchase a product, and/or perform a conversion action, among other examples.

Additionally, or alternatively, where the user intent level is determined to be between the initial user intent level and the final user intent level, the CTA element may collapse, disappear, or otherwise be updated to be relatively less visually prominent, until the user intent level satisfies one or more conditions associated with the final user intent level. For example, the CTA element may display the unanimated “First, Go & Learn More” content when a user initially visits the website, and the CTA element may disappear as the user begins to interact with the website. The CTA element may then reappear to display the animated “You're ready to apply!” content when the user intent level is determined to be at the final user intent level.

As described herein, some implementations may provide dynamic and personalized CTA elements and/or web pages in order to strategically engage users based on user behavior associated with the web page. For example, the CTA elements may be dynamically updated to provide content with engagement properties that nurture a customer towards engaging with the CTA element and/or taking additional action associated with the web page. Accordingly, by adapting and optimizing the engagement properties associated with the CTA elements, the techniques described herein may conserve resources that may otherwise be consumed where the user leaves the web page, is unable to efficiently navigate the webpage, or becomes inactive on the web page.

As indicated above, FIGS. 2A-2B are provided as examples. Other examples may differ from what is described with regard to FIGS. 2A-2B.

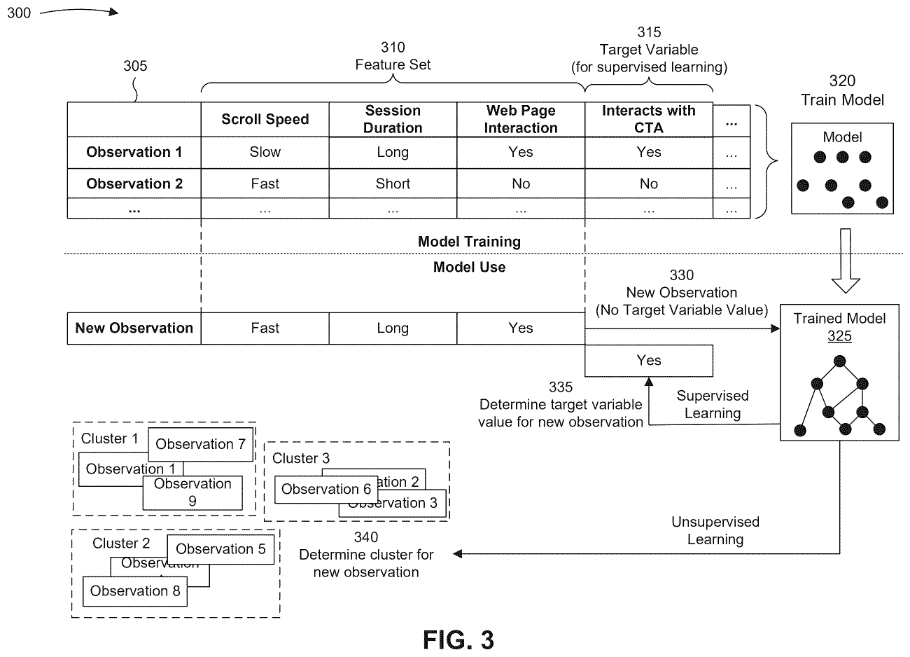

FIG. 3 is a diagram of an example 300 of training and using a machine learning model in connection with a dynamic CTA adaptation system. The machine learning model training and usage described herein may be performed using a machine learning system. The machine learning system may include or may be included in a computing device, a server, a cloud computing environment, or the like, such as the server and/or the user device described in more detail elsewhere herein.

As shown by reference number 305, a machine learning model may be trained using a set of observations. The set of observations may be obtained from training data (e.g., historical data), such as data gathered during one or more processes described herein. In some implementations, the machine learning system may receive the set of observations (e.g., as input) from a server, a user device, a user context data repository, and/or another suitable data source, as described elsewhere herein.

As shown by reference number 310, the set of observations may include a feature set. The feature set may include a set of variables, and a variable may be referred to as a feature. A specific observation may include a set of variable values (or feature values) corresponding to the set of variables. In some implementations, the machine learning system may determine variables for a set of observations and/or variable values for a specific observation based on input received from a server, a user device, a user context data repository, and/or another suitable data source. For example, the machine learning system may identify a feature set (e.g., one or more features and/or feature values) by extracting the feature set from structured data, by performing natural language processing and/or computer vision processing to extract the feature set from unstructured data, and/or by receiving input from an operator.

As an example, a feature set for a set of observations may include a first feature of Scroll Speed, a second feature of Session Duration, a third feature of Web Page Interaction, and so on. As shown, for a first observation, the first feature may have a value of Slow (e.g., indicating that the user is scrolling up or down and/or left or right on a web page at a relatively slow speed according to one or more scroll speed conditions or thresholds), the second feature may have a value of Long (e.g., indicating that the current web page session is associated with a long time duration according to one or more time duration conditions and/or thresholds), the third feature may have a value of Yes (e.g., indicating that the user has interacted with certain UI elements of the web page according to one or more interaction conditions and/or indicating that the user has interacted with a quantity of UI elements that satisfies (e.g., meets or exceeds) an interaction threshold), and so on. These features and feature values are provided as examples, and may differ in other examples. For example, the feature set may include one or more of the following features: text input, time duration of hovering over a UI element, video and/or audio plays, navigation path (e.g., navigation to a linked page, navigation path associated with the user journey to the web page, or the like), highlighting and/or copying and pasting web page content, utilization of web browser plugins, eye tracking data, and/or rage clicking, among other examples.

As shown by reference number 315, the set of observations may be associated with a target variable. The target variable may represent a variable having a binary attribute (e.g., yes or no), may represent a numeric value, may represent a variable having a numeric value that falls within a range of values or has some discrete possible values, may represent a variable that is selectable from one of multiple options (e.g., one of multiples classes, classifications, or labels) and/or may represent a variable having a Boolean value. A target variable may be associated with a target variable value, and a target variable value may be specific to an observation. In example 300, the target variable is Interacts with CTA, which has a value of Yes for the first observation.

The feature set and target variable described above are provided as examples, and other examples may differ from what is described above. For example, for a target variable of Video Plays, the feature set may include a No option (e.g., the user did not start playing a video), a Started option (e.g., the user started playing a video), an Abandoned option (e.g., the user started playing a video but did not finish playing the full video), a Completed option (e.g., the user started playing a video and finished playing the full video), or the like.

The target variable may represent a value that a machine learning model is being trained to predict, and the feature set may represent the variables that are input to a trained machine learning model to predict a value for the target variable. The set of observations may include target variable values so that the machine learning model can be trained to recognize patterns in the feature set that lead to a target variable value. A machine learning model that is trained to predict a target variable value may be referred to as a supervised learning model.

In some implementations, the machine learning model may be trained on a set of observations that do not include a target variable. This may be referred to as an unsupervised learning model. In this case, the machine learning model may learn patterns from the set of observations without labeling or supervision, and may provide output that indicates such patterns, such as by using clustering and/or association to identify related groups of items within the set of observations.

As shown by reference number 320, the machine learning system may train a machine learning model using the set of observations and using one or more machine learning algorithms, such as a regression algorithm, a decision tree algorithm, a neural network algorithm, a k-nearest neighbor algorithm, a support vector machine algorithm, or the like. After training, the machine learning system may store the machine learning model as a trained machine learning model 325 to be used to analyze new observations.

As an example, the machine learning system may obtain training data for the set of observations based on historical data indicating whether a user has interacted with a CTA, historical engagement properties associated with one or more CTA elements and/or updated engagement properties associated with one or more CTA elements that have been presented to one or more users, detected user device types, or the like.

As shown by reference number 330, the machine learning system may apply the trained machine learning model 325 to a new observation, such as by receiving a new observation and inputting the new observation to the trained machine learning model 325. As shown, the new observation may include a first feature of Fast (e.g., indicating that the user is scrolling up or down and/or left or right on a web page at a relatively high speed according to one or more scroll speed conditions or thresholds), a second feature of Long (e.g., indicating that the current web page session is associated with a long time duration according to one or more time duration conditions and/or thresholds), and a third feature of Yes (e.g., indicating that the user has interacted with certain UI elements of the web page according to one or more interaction conditions and/or indicating that the user has interacted with a quantity of UI elements that satisfies (e.g., meets or exceeds) an interaction threshold), and so on, as an example. The machine learning system may apply the trained machine learning model 325 to the new observation to generate an output (e.g., a result). The type of output may depend on the type of machine learning model and/or the type of machine learning task being performed. For example, the output may include a predicted value of a target variable, such as when supervised learning is employed. Additionally, or alternatively, the output may include information that identifies a cluster to which the new observation belongs and/or information that indicates a degree of similarity between the new observation and one or more other observations, such as when unsupervised learning is employed.

As an example, the trained machine learning model 325 may predict a value of Yes for the target variable of Interacts with CTA for the new observation, as shown by reference number 335. Based on this prediction, the machine learning system may provide a first recommendation, may provide output for determination of a first recommendation, may perform a first automated action, and/or may cause a first automated action to be performed (e.g., by instructing another device to perform the automated action), among other examples. The first recommendation may include, for example, a recommendation to update engagement properties associated with the CTA element in order to encourage the user to interact with the CTA element and/or to retain user engagement with the web page. The first automated action may include, for example, updating engagement properties associated with the CTA element in order to dynamically update the content displayed to the user in an attempt to encourage the user to interact with the CTA element and/or to retain the user on the web page.

As another example, if the machine learning system were to predict a value of No for the target variable of Interacts with CTA, then the machine learning system may provide a second (e.g., different) recommendation (e.g., recommending that the server refrain from updating the engagement properties to a final state that is associated with a final user intent level), and/or may perform or cause performance of a second (e.g., different) automated action (e.g., skip a potential update of engagement properties for the CTA element).

In some implementations, the trained machine learning model 325 may classify (e.g., cluster) the new observation in a cluster, as shown by reference number 340. The observations within a cluster may have a threshold degree of similarity. As an example, if the machine learning system classifies the new observation in a first cluster (e.g., user interacts with CTA), then the machine learning system may provide a first recommendation, such as the first recommendation described above. Additionally, or alternatively, the machine learning system may perform a first automated action and/or may cause a first automated action to be performed (e.g., by instructing another device to perform the automated action) based on classifying the new observation in the first cluster, such as the first automated action described above.

As another example, if the machine learning system were to classify the new observation in a second cluster (e.g., user does not interact with CTA), then the machine learning system may provide a second (e.g., different) recommendation, such as the second recommendation described above, and/or may perform or cause performance of a second (e.g., different) automated action, such as the second automated action described above.

In some implementations, the recommendation and/or the automated action associated with the new observation may be based on a target variable value having a particular label (e.g., classification or categorization), may be based on whether a target variable value satisfies one or more thresholds (e.g., whether the target variable value is greater than a threshold, is less than a threshold, is equal to a threshold, falls within a range of threshold values, or the like), and/or may be based on a cluster in which the new observation is classified.

In some implementations, the trained machine learning model 325 may be re-trained using feedback information. For example, feedback may be provided to the machine learning model. The feedback may be associated with actions performed based on the recommendations provided by the trained machine learning model 325 and/or automated actions performed, or caused, by the trained machine learning model 325. In other words, the recommendations and/or actions output by the trained machine learning model 325 may be used as inputs to re-train the machine learning model (e.g., a feedback loop may be used to train and/or update the machine learning model). For example, the feedback information may include information that is obtained or otherwise gathered via an instance of dynamically adapting a CTA based on behavior information associated with a user.

In this way, the machine learning system may apply a rigorous and automated process to determine whether and how to update engagement properties associated with the CTA element. The machine learning system may enable recognition and/or identification of tens, hundreds, thousands, or millions of features and/or feature values for tens, hundreds, thousands, or millions of observations, thereby increasing accuracy and consistency and reducing delay associated with updating engagement properties associated with the CTA element based on behavior information associated with the user, relative to requiring computing resources to be allocated for tens, hundreds, or thousands of operators to manually update engagement properties associated with the CTA element based on behavior information associated with the user.

As indicated above, FIG. 3 is provided as an example. Other examples may differ from what is described with regard to FIG. 3.

FIG. 4 is a diagram of an example environment 400 in which systems and/or methods described herein may be implemented. As shown in FIG. 4, environment 400 may include a user device 410, a server 420, and a network 430. Devices of environment 400 may interconnect via wired connections, wireless connections, or a combination of wired and wireless connections.

The user device 410 may include one or more devices capable of receiving, generating, storing, processing, and/or providing information associated with dynamic CTA adaptation, as described elsewhere herein. The user device 410 may include a communication device and/or a computing device. For example, the user device 410 may include a wireless communication device, a mobile phone, a user equipment, a laptop computer, a tablet computer, a desktop computer, a gaming console, a set-top box, a wearable communication device (e.g., a smart wristwatch, a pair of smart eyeglasses, a head mounted display, or a virtual reality headset), or a similar type of device.

The server 420 may include one or more devices capable of receiving, generating, storing, processing, providing, and/or routing information associated with dynamic CTA adaptation, as described elsewhere herein. The server 420 may include a communication device and/or a computing device. For example, the server 420 may include a server, such as an application server, a client server, a web server, a database server, a host server, a proxy server, a virtual server (e.g., executing on computing hardware), a content server, or a server in a cloud computing system. In some implementations, the server 420 may include computing hardware used in a cloud computing environment, such as one or more serverless components (e.g., one or more serverless functions).

The network 430 may include one or more wired and/or wireless networks. For example, the network 430 may include a wireless wide area network (e.g., a cellular network or a public land mobile network), a local area network (e.g., a wired local area network or a wireless local area network (WLAN), such as a Wi-Fi network), a personal area network (e.g., a Bluetooth network), a near-field communication network, a telephone network, a private network, the Internet, and/or a combination of these or other types of networks. The network 430 enables communication among the devices of environment 400.

The number and arrangement of devices and networks shown in FIG. 4 are provided as an example. In practice, there may be additional devices and/or networks, fewer devices and/or networks, different devices and/or networks, or differently arranged devices and/or networks than those shown in FIG. 4. Furthermore, two or more devices shown in FIG. 4 may be implemented within a single device, or a single device shown in FIG. 4 may be implemented as multiple, distributed devices. Additionally, or alternatively, a set of devices (e.g., one or more devices) of environment 400 may perform one or more functions described as being performed by another set of devices of environment 400.

FIG. 5 is a diagram of example components of a device 500 associated with a dynamic CTA adaptation system. The device 500 corresponds to one or more of a user device and/or a server. In some implementations, the user device and/or the server include one or more devices 500 and/or one or more components of the device 500. In the example shown in FIG. 5, the device 500 includes a bus 510, a processor 520, a memory 530, an input component 540, an output component 550, and/or a communication component 560.

The bus 510 includes one or more components that enable wired and/or wireless communication among the components of the device 500. The bus 510 couples together two or more components of FIG. 5, such as via operative coupling, communicative coupling, electronic coupling, and/or electric coupling. For example, the bus 510 may include an electrical connection (e.g., a wire, a trace, and/or a lead) and/or a wireless bus. The processor 520 includes a central processing unit, a graphics processing unit, a microprocessor, a controller, a microcontroller, a digital signal processor, a field-programmable gate array, an application-specific integrated circuit, and/or another type of processing component. The processor 520 may be implemented in hardware, firmware, or a combination of hardware and software. In some implementations, the processor 520 includes one or more processors capable of being programmed to perform one or more operations or processes described elsewhere herein.

The memory 530 includes volatile and/or nonvolatile memory, such as random access memory (RAM), read only memory (ROM), a hard disk drive, and/or another type of memory (e.g., a flash memory, a magnetic memory, and/or an optical memory). The memory 530 may include internal memory (e.g., RAM, ROM, or a hard disk drive) and/or removable memory (e.g., removable via a universal serial bus connection). In some implementations, the memory 530 is a non-transitory computer-readable medium. The memory 530 stores information, one or more instructions, and/or software (e.g., one or more software applications) related to the operation of the device 500. In some implementations, the memory 530 includes one or more memories that are coupled (e.g., communicatively coupled) to one or more processors (e.g., processor 520), such as via the bus 510. Communicative coupling between a processor 520 and a memory 530 enables the processor 520 to read and/or process information stored in the memory 530 and/or to store information in the memory 530.

The input component 540 enables the device 500 to receive input, such as user input and/or sensed input. For example, the input component 540 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 550 enables the device 500 to provide output, such as via a display, a speaker, and/or a light-emitting diode. The communication component 560 enables the device 500 to communicate with other devices via a wired connection and/or a wireless connection. For example, the communication component 560 may include a receiver, a transmitter, a transceiver, a modem, a network interface card, and/or an antenna.

In some implementations, the device 500 performs one or more operations or processes described herein. For example, a non-transitory computer-readable medium (e.g., memory 530) may store a set of instructions (e.g., one or more instructions or code) for execution by the processor 520. The processor 520 may execute the set of instructions to perform one or more operations or processes described herein. In some implementations, execution of the set of instructions, by one or more processors 520, causes the one or more processors 520 and/or the device 500 to perform one or more operations or processes described herein. In some implementations, hardwired circuitry is used instead of or in combination with the instructions to perform one or more operations or processes described herein. Additionally, or alternatively, the processor 520 may be configured to perform one or more operations or processes described herein. Thus, implementations described herein are not limited to any specific combination of hardware circuitry and software.

The number and arrangement of components shown in FIG. 5 are provided as an example. The device 500 may include additional components, fewer components, different components, or differently arranged components than those shown in FIG. 5. Additionally, or alternatively, a set of components (e.g., one or more components) of the device 500 may perform one or more functions described as being performed by another set of components of the device 500.

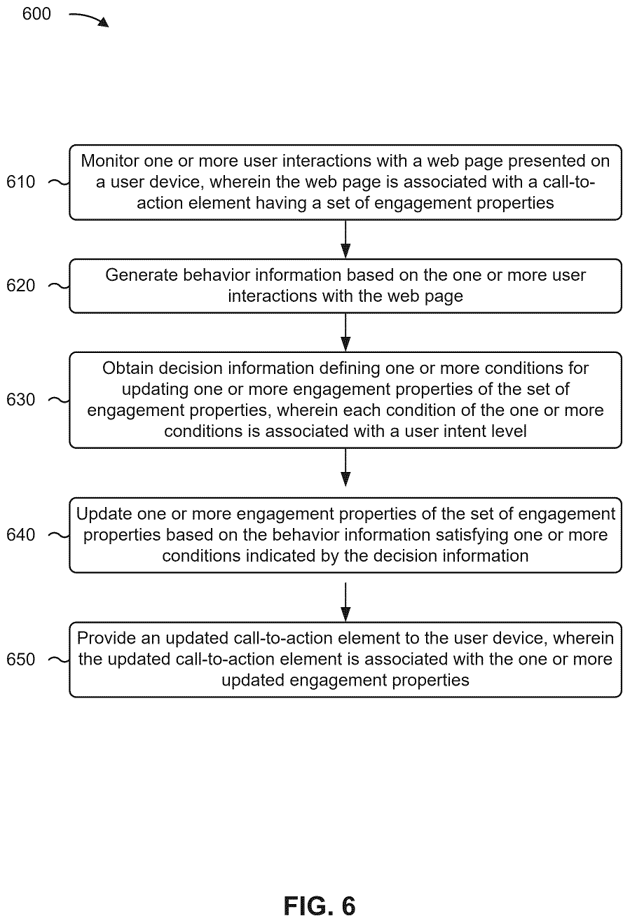

FIG. 6 is a flowchart of an example process 600 associated with a dynamic CTA adaptation system. In some implementations, one or more process blocks of FIG. 6 may be performed by the server 420. In some implementations, one or more process blocks of FIG. 6 may be performed by another device or a group of devices separate from or including the server 420, such as the user device 410. Additionally, or alternatively, one or more process blocks of FIG. 6 may be performed by one or more components of the device 500, such as processor 520, memory 530, input component 540, output component 550, and/or communication component 560.

As shown in FIG. 6, process 600 may include monitoring one or more user interactions with a web page presented on a user device (block 610). For example, the server 420 (e.g., using processor 520 and/or memory 530) may monitor one or more user interactions with a web page presented on a user device, as described above in connection with reference number 115 of FIG. 1. As an example, where a user is viewing and/or interacting with a web page, the server 420 may collect interaction data associated with the user, including mouse movements, clicks, interactions, video and/or audio plays, event tracking, scroll speed, navigation path, and/or text input, among other examples. In some implementations, the web page is associated with a CTA element having a set of engagement properties. As an example, the web page may include a CTA button that is associated with dynamic properties, including visual properties (e.g., color, shape, or the like), content (e.g., text, images, graphics, or the like), and/or animation properties, among other examples.

As further shown in FIG. 6, process 600 may include generating behavior information based on the one or more user interactions with the web page (block 620). For example, the server 420 (e.g., using processor 520 and/or memory 530) may generate behavior information based on the one or more user interactions with the web page, as described above in connection with reference number 120 of FIG. 1. As an example, where the user is interacting with an ecommerce web page, the server 420 may determine a user-intent level based on the user's interactions (e.g., clicks, scroll speed, session duration, or the like) with the web page. As a result, the determined user-intent level may indicate the user's relative likelihood of engaging with the CTA element.

As further shown in FIG. 6, process 600 may include obtaining decision information defining one or more conditions for updating one or more engagement properties of the set of engagement properties (block 630). For example, the server 420 (e.g., using processor 520 and/or memory 530) may obtain decision information defining one or more conditions for updating one or more engagement properties of the set of engagement properties, as described above in connection with reference numbers 130 and 135 of FIG. 1. As an example, the server may obtain conditions and/or thresholds associated with different types of interaction data (e.g., clicks, scroll speed, session duration, or the like), and each condition and/or threshold is associated with a different user intent level. As a result, the decision information may indicate that where, for example, the quantity of clicks satisfies (e.g., meets or exceeds) a threshold associated with high user intent, then this behavior information may be assigned a high user intent level. In some implementations, each condition of the one or more conditions is associated with a user intent level. As an example, a condition associated with a high number of interactions and a long session duration may indicate a high user intent level, where the user may have a high likelihood of engaging with the CTA element

As further shown in FIG. 6, process 600 may include updating one or more engagement properties of the set of engagement properties based on the behavior information satisfying one or more conditions indicated by the decision information (block 640). For example, the server 420 (e.g., using processor 520 and/or memory 530) may update one or more engagement properties of the set of engagement properties based on the behavior information satisfying one or more conditions indicated by the decision information, as described above in connection with reference number 135 of FIG. 1. As an example, where the quantity of clicks (e.g., user interactions) satisfies (e.g., meets or exceeds) a threshold for a high user-intent level, the server 420 may update the CTA button to correspond to the high likelihood that the user is ready to engage the CTA button, thereby encouraging the user to engage with the CTA button.

As further shown in FIG. 6, process 600 may include providing an updated CTA element to the user device (block 650). For example, the server 420 (e.g., using processor 520 and/or memory 530) may provide an updated CTA element to the user device, as described above in connection with reference number 140 of FIG. 1. As an example, the CTA button on the web page may be dynamically updated to include different properties (e.g., visual properties, animations, or the like) and/or different content (e.g., textual content, graphics, images, or the like) than the previous properties and/or content associated with the CTA button. In some implementations, the updated CTA element is associated with the one or more updated engagement properties. As an example, the updated properties associated with the CTA button may be relevant to the determined user intent level, where for example, the updated properties may encourage the user to interact with the CTA button when the user is associated with a high user intent level. In contrast, for example, the updated properties may encourage the user to continue browsing the web page before engaging with the CTA button, when the user is associated with a low user intent level.

Although FIG. 6 shows example blocks of process 600, in some implementations, process 600 may include additional blocks, fewer blocks, different blocks, or differently-arranged blocks than those depicted in FIG. 6. Additionally, or alternatively, two or more of the blocks of process 600 may be performed in parallel. The process 600 is an example of one process that may be performed by one or more devices described herein. These one or more devices may perform one or more other processes based on operations described herein, such as the operations described in connection with FIGS. 1, 2A, and 2B. Moreover, while the process 600 has been described in relation to the devices and components of the preceding figures, the process 600 can be performed using alternative, additional, or fewer devices and/or components. Thus, the process 600 is not limited to being performed with the example devices, components, hardware, and software explicitly enumerated in the preceding figures.

The foregoing disclosure provides illustration and description, but is not intended to be exhaustive or to limit the implementations to the precise forms disclosed. Modifications may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The hardware and/or software code described herein for implementing aspects of the disclosure should not be construed as limiting the scope of the disclosure. Thus, the operation and behavior of the systems and/or methods are described herein without reference to specific software code-it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination and permutation of those items, including single members. As an example, “at least one of: a, b, or c” is intended to cover a, b, c, a-b, a-c, b-c, and a-b-c, as well as any combination with multiple of the same item. As used herein, the term “and/or” used to connect items in a list refers to any combination and any permutation of those items, including single members (e.g., an individual item in the list). As an example, “a, b, and/or c” is intended to cover a, b, c, a-b, a-c, b-c, and a-b-c.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A system for dynamic call-to-action adaptation, the system comprising:
one or more memories; and
one or more processors, communicatively coupled to the one or more memories, configured to:
monitor one or more user interactions with a web page presented on a user device,
wherein the web page is associated with a call-to-action element having a set of engagement properties;
generate behavior information based on the one or more user interactions with the web page;
obtain decision information defining one or more conditions for updating one or more engagement properties of the set of engagement properties,
wherein each condition of the one or more conditions is associated with a user intent level;
update one or more engagement properties of the set of engagement properties based on the behavior information satisfying one or more conditions indicated by the decision information,
wherein each updated engagement property is updated from a first respective action state to a second respective action state; and
provide an updated call-to-action element to the user device,
wherein the updated call-to-action element is associated with the one or more updated engagement properties.

2. The system of claim 1, wherein the one or more processors are further configured to:
skip the updating of the one or more engagement properties based on the behavior information satisfying one or more conditions associated with a final user intent level.

3. The system of claim 1, wherein the behavior information is generated based on historical user interactions with at least one of the web page or one or more web pages that are associated with the web page.

4. The system of claim 1, wherein the one or more processors, to update the one or more engagement properties, are further configured to:
update a destination resource link associated with the call-to-action element, based on the behavior information satisfying one or more conditions indicated by the decision information.

5. The system of claim 1, wherein the behavior information is based on one or more user interactions with one or more content elements associated with the web page.

6. The system of claim 1, wherein the one or more user interactions include interactions with one or more user interface platforms associated with the web page.

7. The system of claim 1, wherein the one or more processors are further configured to:
obtain predicted behavior information associated with the web page,
wherein the predicted behavior information is based on the behavior information; and
update the one or more engagement properties based on the predicted behavior information satisfying one or more conditions indicated by the decision information.

8. A method for dynamic call-to-action adaptation, comprising:
monitoring, by a system, one or more user interactions with a web page presented on a user device,
wherein the web page is associated with a call-to-action element having a set of engagement properties;
generating, by the system, behavior information based on the one or more user interactions with the web page;
obtaining, by the system, decision information defining one or more conditions for updating one or more engagement properties of the set of engagement properties,
wherein each condition of the one or more conditions is associated with a user intent level;
updating, by the system, one or more engagement properties of the set of engagement properties based on the behavior information satisfying one or more conditions indicated by the decision information; and
providing, by the system, an updated call-to-action element to the user device,
wherein the updated call-to-action element is associated with the one or more updated engagement properties.

9. The method of claim 8, wherein each updated engagement property is updated from a respective action state to a final respective action state based on the behavior information satisfying one or more conditions associated with a final user intent level.

10. The method of claim 8, wherein the behavior information is generated based on historical user interactions with at least one of the web page or one or more web pages that are associated with the web page.

11. The method of claim 8, wherein updating the one or more engagement properties comprises: updating a destination resource link associated with the call-to-action element, based on the behavior information satisfying one or more conditions indicated by the decision information.

12. The method of claim 8, wherein the behavior information is based on one or more user interactions with one or more content elements associated with the web page.

13. The method of claim 8, wherein the one or more user interactions include interactions with one or more user interface platforms associated with the web page.

14. The method of claim 8, further comprising:
obtaining predicted behavior information associated with the web page,
wherein the predicted behavior information is based on the behavior information; and
updating the one or more engagement properties based on the predicted behavior information satisfying one or more conditions indicated by the decision information.

15. A non-transitory computer-readable medium storing a set of instructions, the set of instructions comprising: one or more instructions that, when executed by one or more processors of a system, cause the system to:
monitor one or more user interactions with a web page presented on a user device,
wherein the web page is associated with a call-to-action element having a set of engagement properties;
generate behavior information based on the one or more user interactions with the web page;
obtain decision information defining one or more conditions for updating one or more engagement properties of the set of engagement properties;
update one or more engagement properties of the set of engagement properties based on the behavior information satisfying one or more conditions indicated by the decision information; and
provide an updated call-to-action element to the user device,
wherein the updated call-to-action element is associated with the one or more updated engagement properties.

16. The non-transitory computer-readable medium of claim 15, wherein the behavior information is generated based on historical user interactions with at least one of the web page or one or more web pages that are associated with the web page.

17. The non-transitory computer-readable medium of claim 15, wherein the one or more instructions, that cause the system to update the one or more engagement properties, cause the system to:
update a destination resource link associated with the call-to-action element, based on the behavior information satisfying one or more conditions indicated by the decision information.

18. The non-transitory computer-readable medium of claim 15, wherein the behavior information is based on one or more user interactions with one or more content elements associated with the web page.

19. The non-transitory computer-readable medium of claim 15, wherein the one or more instructions further cause the system to:
obtain predicted behavior information associated with the web page,
wherein the predicted behavior information is based on the behavior information; and
update the one or more engagement properties based on the predicted behavior information satisfying one or more conditions indicated by the decision information.

20. The non-transitory computer-readable medium of claim 15, wherein the one or more user interactions include interactions with one or more user interface platforms associated with the web page.
